(19) United States
(12) Patent Application Publication
(10) Pub. No.: US 2012/0132473 A1
(43) Pub. Date: May 31, 2012

(54) CORNER ASSEMBLY FOR VEHICLE

(76) Inventors: James L. Weber, West Bloomfield, MI (US); Zhesheng Li, Rochester, MI (US); Todd A. Kendall, Macomb, MI (US)

(21) Appl. No.: 13/254,838

(22) PCT Filed: Mar. 2, 2010
(86) PCT No.: PCT/US2010/025916

§ 371 Date: Dec. 19, 2011

Related U.S. Application Data
(60) Provisional application No. 61/156,620, filed on Mar. 2, 2009.

(51) Int. Cl. B60K 7/00; B23P 11/00; B60K 1/00

(52) U.S. Cl. 180/58; 301/6.5; 29/897

(57) ABSTRACT

In a first aspect, the invention is directed to a wheel assembly for a vehicle, including a non-rotating support member, a wheel and an electric motor. Loads incurred during vehicle use can cause dynamic flexing of portions of the wheel. The wheel assembly in accordance with the first aspect of the invention has a load path for loads incurred by the wheel that passes from the wheel to the non-rotating support member without passing through the motor, thereby reducing a potential source of distortion of the gap in the motor (between the motor's rotor and stator) during the aforementioned flexing.

### FIELD OF THE INVENTION

The present invention relates to electric vehicles (ie. vehicles that are powered at least partly by an electric motor) and more particularly to electric vehicles with drive motors that are positioned at one or more wheels.

### BACKGROUND OF THE INVENTION

Electric vehicles offer the promise of powered transportation through the use of electric motors while producing few or no emissions. Some electric vehicles are powered by electric motors only and rely solely on the energy stored in an on-board battery pack. Other electric vehicles are hybrids, and include an internal combustion engine, which may, for example, be used to assist the electric motor in driving the wheels (a parallel hybrid), or which may, for example, be used solely to charge the on-board battery pack, thereby extending the operating range of the vehicle (a series hybrid). Yet other electric vehicles are in the form of fuel cell vehicles, which use on-board fuel cells to produce electrical energy for powering one or more electric motors, which in turn drive the vehicle's wheels. In some vehicles, there is a single, centrally-positioned electric motor that powers one or more of the vehicle wheels, and in other vehicles, one or more of the wheels have an electric motor positioned at each driven wheel.

While currently proposed and existing vehicles are advantageous in some respects over internal-combustion engine powered vehicles, there are problems that are associated with some electric vehicles. For example, the electric motors can be expensive to replace. It would thus be advantageous to be able to provide an electric motor with an extended operating life. A separate issue is that some electric vehicles can achieve high speed, but would benefit from being able to generate high torque when needed. It would also be advantageous to provide a drive assembly for an electric vehicle that could be easily tailored by the manufacturer to meet the needs of different applications. In other words, it would be advantageous if the manufacturer could easily change the gearing in the drive assembly for different applications.

### SUMMARY OF THE INVENTION

In a first aspect, the invention is directed to a wheel assembly for a vehicle, including a non-rotating support member, a wheel and an electric motor. Loads incurred during vehicle use can cause dynamic flexing of portions of the wheel. The wheel assembly in accordance with the first aspect of the invention has a load path for loads incurred by the wheel that passes from the wheel to the non-rotating support member without passing through the motor, thereby reducing a potential source of distortion of the gap in the motor (between the motor's rotor and stator) during the aforementioned flexing.

In a particular embodiment of the first aspect, the invention is directed to a wheel assembly for a vehicle, including a non-rotating support member, a wheel and an electric motor. The wheel includes a rim, a spider and a wheel hub. The rim has a radially inner surface. The wheel is rotatably supported by the non-rotating support member for rotation about a wheel axis. The electric motor has an axially extending motor aperture. The electric motor includes a non-rotating motor portion and a rotating motor portion. The rotating motor portion is operatively connected to the wheel and is spaced from the radially inner surface of the rim for substantial isolation from any radially inwardly directed forces from the radially inner surface of the rim. The non-rotating motor portion is fixedly connected to the non-rotating support member.

In a second aspect, the invention is directed to a wheel assembly for a vehicle, including a non-rotating support member, a wheel and an electric motor. The support of the motor is separate from that of the wheel to at least somewhat isolate the motor from vibrations that are incurred at the wheel during vehicle use.

In a particular embodiment of the second aspect, the invention is directed to a wheel assembly for a vehicle, including a non-rotating support member, a wheel and an electric motor. The wheel is rotatably supported by the non-rotating support member through a first wheel bearing and a second wheel bearing. The electric motor has an axially extending motor aperture. The electric motor includes a non-rotating motor portion and a rotating motor portion. The rotating motor portion is operatively connected to the wheel. The rotating motor portion is supported by the non-rotating support member though a first motor bearing and a second motor bearing.

In a third aspect, the invention is directed to a drive assembly for a vehicle, including a non-rotating support member, an electric motor and a gearbox. The gearbox provides at least two selectable ratios.

In a particular embodiment of the third aspect, the invention is directed to a drive assembly for a vehicle, including a non-rotating support member, an electric motor and a gearbox. The wheel is rotatably supported by the non-rotating support member. The electric motor is supported by the non-rotating support member. The electric motor includes a non-rotating motor portion and a rotating motor portion. The rotating motor portion is operatively connected to the gearbox and the gearbox is operatively connected to the wheel. The gearbox has at least two selectable ratios associated therewith.

In a fourth aspect, the invention is directed to an electric motor with a cooling jacket that is a separate element from the motor housing. By making the cooling jacket a separate element, the cooling jacket may be tested prior to assembly of the motor. Further, the cooling jacket could be tested prior to shipping from the cooling jacket manufacturer to the motor assembler (in situations wherein these are two different manufacturing facilities), thereby reducing the costs associated with the return of defective product to the cooling jacket manufacturer. As another advantage, the cooling jacket can be manufactured without o-rings or other mechanical seals, thereby eliminating a source of eventual failure after prolonged use.

In a particular embodiment of the fourth aspect, the invention is directed to an electric motor for driving a wheel of a vehicle including a stator, a rotor, a motor housing that houses the stator and rotor, and a cooling jacket. The cooling jacket includes a jacket housing and a channel structure contained within the jacket housing for directing a flow of fluid. The jacket housing includes a fluid inlet and a fluid outlet for the fluid. The cooling jacket housing is positioned to direct heat from at least the stator into fluid in the channel structure. The jacket housing is separate from the motor housing.

In a fifth aspect, the invention is directed to an electric motor with a cooling jacket that is positioned in a motor interior within the motor housing. By having the cooling jacket in the motor interior, the cooling jacket is advantageously positioned for transferring heat from the motor interior to fluid in the cooling jacket.

In a particular embodiment of the fifth aspect, the invention is directed to an electric motor for driving a wheel of a vehicle including a stator, a rotor, a motor housing that houses the stator and rotor and defines a motor interior, and a cooling jacket. The cooling jacket is positioned in the motor interior and is configured for holding a flow of fluid. The cooling jacket is positioned to direct heat from components of the motor such as the stator into the flow of fluid.

In a sixth aspect, the invention is directed to an electric motor with a cooling jacket that is positioned in a motor interior within the motor housing. By having the cooling jacket in the motor interior, the cooling jacket is advantageously positioned for transferring heat from the motor interior to fluid in the cooling jacket.

In a particular embodiment of the sixth aspect, the invention is directed to an electric motor for driving a wheel of a vehicle including a stator, a rotor, a motor housing that houses the stator and rotor, and a cooling jacket. The stator is mounted to the cooling jacket. The cooling jacket is configured for holding a flow of fluid and for directing heat from at least the stator into the flow of fluid.

In a seventh aspect, the invention is directed to a corner assembly for a vehicle, including a non-rotating support member, a wheel, an electric motor and a lower control arm. The lower control arm defines an upwardly-facing channel that holds electrical conduits that extend from the motor, thereby protecting the conduits from damage during vehicle use.

In an eighth aspect, the invention is directed to a drive assembly for a vehicle, including a non-rotating support member, an electric motor and a gearbox. The drive assembly is constructed modularly so that components, such as the gearbox may easily be swapped for another gearbox having different characteristics, such as a different ratio. The drive assembly may be incorporated into a wheel assembly that further includes a wheel and optionally a brake.

In a particular embodiment of the eighth aspect, the invention is directed to a drive assembly for a vehicle, including a non-rotating support member having a non-rotating support member axis, an electric motor and a gearbox. The electric motor has a non-rotating motor portion and a rotating motor portion. The electric motor includes an axially extending motor aperture. The non-rotating support member passes through the motor aperture and supports the electric motor. The rotating motor portion is rotatable relative to the non-rotating support member. The non-rotating motor portion is fixedly mounted to the non-rotating support member. The gearbox has at least one gearbox input member that is rotatable relative to the non-rotating support member and at least one gearbox output member that is rotatable relative to the non-rotating support member. The gearbox includes an axially extending gearbox aperture. The non-rotating support member passes through the gearbox aperture. The gearbox input member is drivable by the rotating motor portion. The drive assembly may be incorporated into a wheel assembly that further includes a wheel and optionally a brake. The wheel has a wheel aperture. The non-rotating support member, specifically a spindle portion of the non-rotating support member, passes through into the wheel aperture and rotatably supports the wheel, optionally via bearings and a wheel hub. The wheel is drivable by the at least one gearbox output member.

In a ninth aspect, the invention is directed to a method of assembling a drive assembly for a vehicle. The drive assembly components mount along an axis, and stack sequentially and modularly. This facilitates assembly, and permits a component to be easily integrated into the drive assembly instead of another component, permitting the drive assembly to be configured for several different applications. The assembly process may be carried by providing a non-rotating support member, mounting a motor to the non-rotating support member, and mounting a gearbox to the non-rotating support member and to the motor. A wheel assembly may be assembled using the drive assembly, a brake and a wheel. The wheel may include a wheel hub, a spider, a rim, a brake rotor and a brake caliper. The wheel hub may be mounted to the non-rotating support member and to the gearbox. The brake rotor, the spider and the rim may be mounted to the wheel hub before or after the mounting of the wheel hub to the non-rotating support member. The wheel assembly can be configured to operate with different wheel sizes by providing different wheel hubs with different pilot and lugnut diameters.

In a particular embodiment of the ninth aspect, the invention is directed to a method of assembling a drive assembly for a vehicle, comprising:

(a) providing a non-rotating support member having a non-rotating support member axis;

(b) axially sliding an electric motor onto the non-rotating support member, wherein the electric motor has a non-rotating motor portion and a rotating motor portion;

(c) fixing the non-rotating motor portion to the non-rotating support member;

(d) providing a gearbox having at least one gearbox input member and at least one gearbox output member;

(e) axially sliding the gearbox onto the non-rotating support member, such that the at least one gearbox input member and the at least one gearbox output member are rotatable relative to the non-rotating support member; and

(f) operatively connecting the rotating motor portion to the at least one gearbox input member.

The drive assembly may be incorporated into a wheel assembly by further method steps, comprising:

(g) axially sliding a wheel onto the non-rotating support member such that the non-rotating support member rotatably supports the wheel; and

(h) operatively connecting the at least one gearbox output member to the wheel.

In a tenth aspect, the invention is directed to a drive assembly that is configured to be compact, permitting operation with a 17″ wheel in some embodiments. The drive assembly includes a non-rotating support member that includes a generally cylindrical knuckle with a ball joint placed therein, a radial flux annular-shaped motor supported on the knuckle, and a gearbox that is driven by the motor.

### BRIEF DESCRIPTION OF THE DRAWINGS

The present invention will now be described, by way of example only, with reference to the attached drawings, in which:

FIG. 1a is a perspective view of a corner assembly for a vehicle in accordance with an embodiment of the present invention;

FIG. 1b is a perspective view from another viewpoint of the corner assembly shown in FIG. 1a, with an element removed to show other selected elements;

FIG. 2 is a sectional side view of the corner assembly shown in FIG. 1a;

FIG. 2a is a sectional side view of a cooling jacket for the motor that is part of the corner assembly shown in FIG. 1a;

FIG. 3 is a sectional side view of the portion of the corner assembly shown in FIG. 1a, including a non-rotating support member and an electric motor;

FIG. 4 is a sectional side view of another portion of the corner assembly shown in FIG. 1a, including a gearbox and a wheel hub, wherein the gearbox is in a first position, providing a single stage of reduction;

FIG. 5 a sectional side view of the portion of the corner assembly shown in FIG. 4, wherein the gearbox is in a second position, providing a two-stage reduction;

FIG. 6 is another perspective view of the corner assembly shown in FIG. 1a;

FIG. 7 is an end view of the inboard end of the corner assembly shown in FIG. 1a;

FIG. 8 is a flow diagram illustrating a method of assembling of a corner assembly in accordance with another embodiment of the present invention;

FIG. 9 is a perspective exploded view of a portion of the corner assembly shown in FIG. 1a; and

FIG. 10 is a perspective cutaway view of an alternative wheel that can be used as part of the corner assembly shown in FIG. 1a.

### DETAILED DESCRIPTION OF THE INVENTION

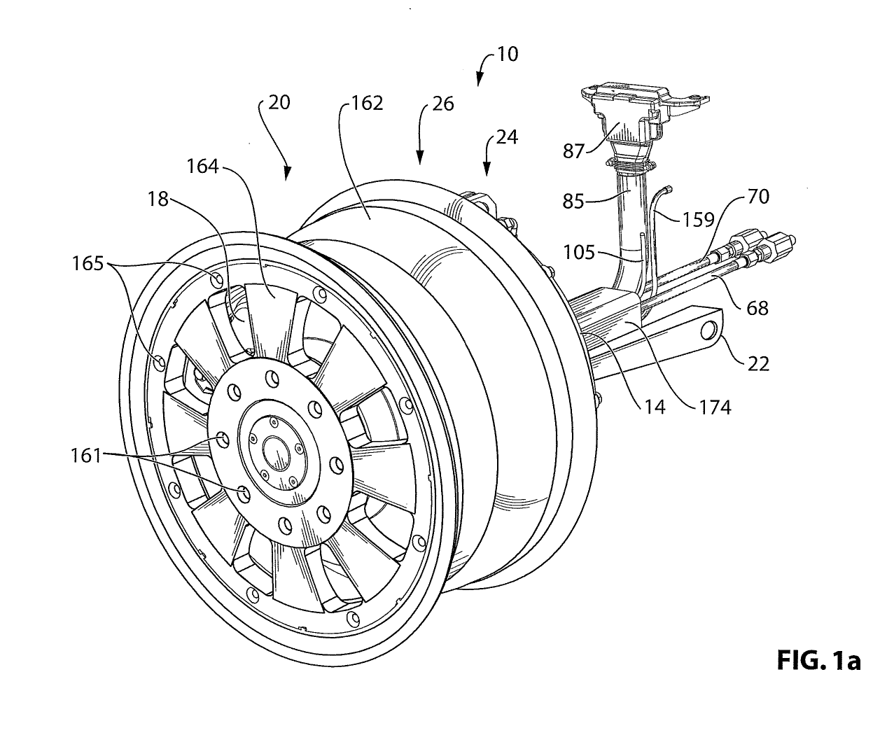

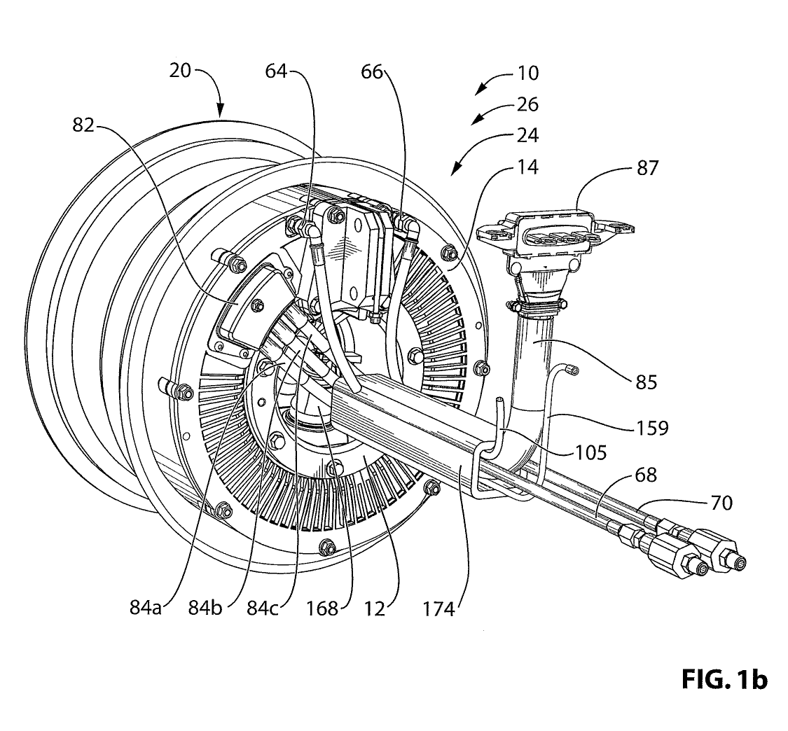

Reference is made to FIG. 1a, which shows a corner assembly 10 for a vehicle (not shown). The corner assembly 10 may be suitable for several types of electrically powered vehicles. For example, embodiments of the corner assembly 10 may be suitable for vehicles that are used on-road (eg. passenger cars), vehicles that will be used off-road (eg. sport-utility vehicles), civilian vehicles, military vehicles, high speed vehicles (eg. sports cars), high-torque vehicles,

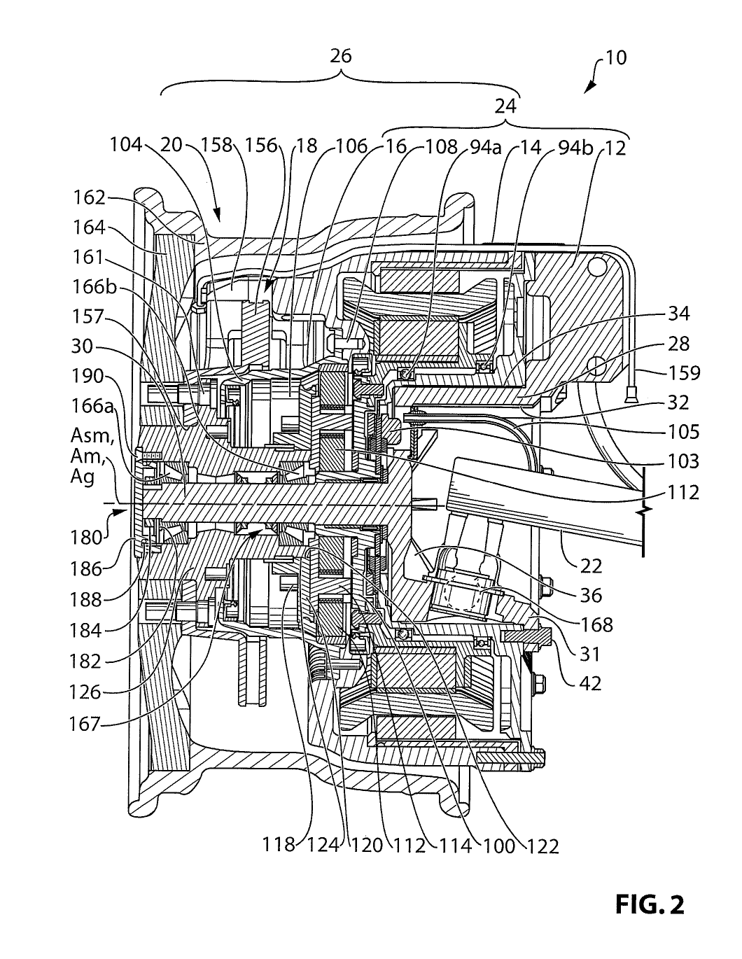

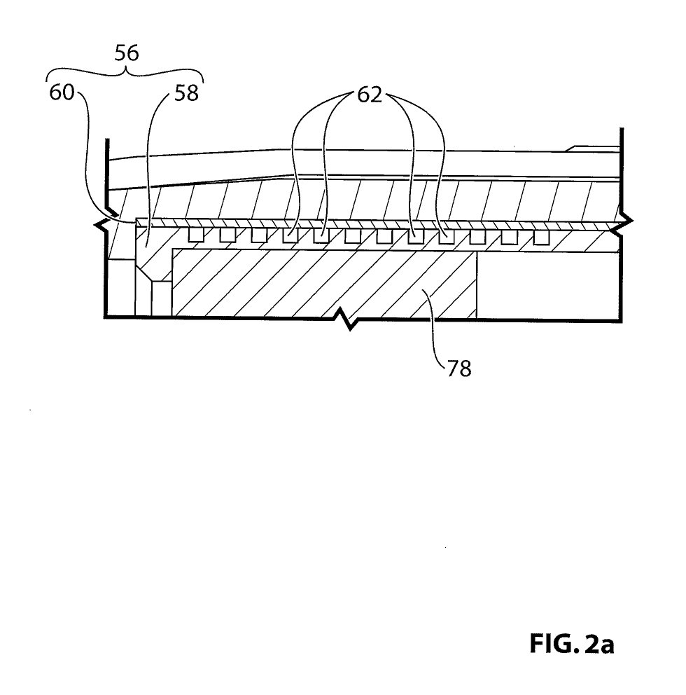

As more clearly shown in FIG. 1b, the corner assembly 10 includes a drive assembly 24, a wheel 20, a brake 18 and a suspension member, (specifically a lower control arm 22). Referring to FIG. 2, the drive assembly 24 includes a non-rotating support member 12, an electric motor 14 and a gearbox 16. The drive assembly 24, the brake 18 and the wheel 20 may together be referred to as a wheel assembly 26.

The non-rotating support member 12 has a non-rotating support member axis Asm associated therewith. The non-rotating support member comprises a knuckle 28, a spindle 30 and a flange 31. The knuckle 28 is axially inboard of the spindle 30 and has a generally axially extending hollow cylindrical shape that has a radially inner surface 32 and a radially outer surface 34. The radially inner surface 32 defines an interior volume 38 of the knuckle 28. A plurality of gussets 36 may be provided to increase the resistance of the knuckle 28 to deformation from a vertically applied load.

The electric motor 14 is supported on the radially outer surface 34 of the knuckle 28. A plurality of motor mounting fasteners 42, which may be, for example, bolts, are used to hold the motor 14 in place on the knuckle 28. For greater clarity, the term ‘bolt’ refers to any threaded fastener that has a thread that is intended for mounting into a tapped (ie. internally threaded) aperture. The motor mounting fasteners 42 extend axially through the flange 31 and into an inner motor housing member, shown at 44. Having the fasteners 42 extend axially facilitates the mounting and dismounting of the electric motor 14 to and from the non-rotating support member 12. It is optionally possible however, for fastening means to be provided that pass radially or in some other way between the electric motor 14 and the non-rotating support member 12.

The motor 14 includes a non-rotating motor portion 46 and a rotating motor portion 48. The non-rotating motor portion 46 includes a housing 50 that may be made up of an outer housing member 52 and the inner housing member 44 that together define a motor interior 53, a stator 54, and an optional cooling jacket 56. Referring to FIG. 2a, the cooling jacket 56 may have any suitable structure. For example, the cooling jacket 56 may include a radially inner jacket housing member 58, a radially outer jacket housing member 60 and an internal channel structure 62 that directs a flow of cooling fluid (eg. a mixture of water and glycol), through the cooling jacket 56 from a fluid inlet 64 (FIG. 1b) to a fluid outlet 66 (FIG. 1b). The cooling jacket 56 transfers heat from the motor interior 53 into the flow of fluid contained therein (eg. the fluid in the channel structure 62).

The radially inner and outer jacket housing members 58 and 60 (FIG. 2a) may be sealingly connected together by any suitable means to prevent leakage of cooling fluid. For example, the jacket housing members 58 and 60 may be welded or brazed together. Referring to FIG. 1b, an inlet fluid conduit 68 and an outlet fluid conduit 70 may be connected to the fluid inlet 64 and fluid outlet 66 respectively.

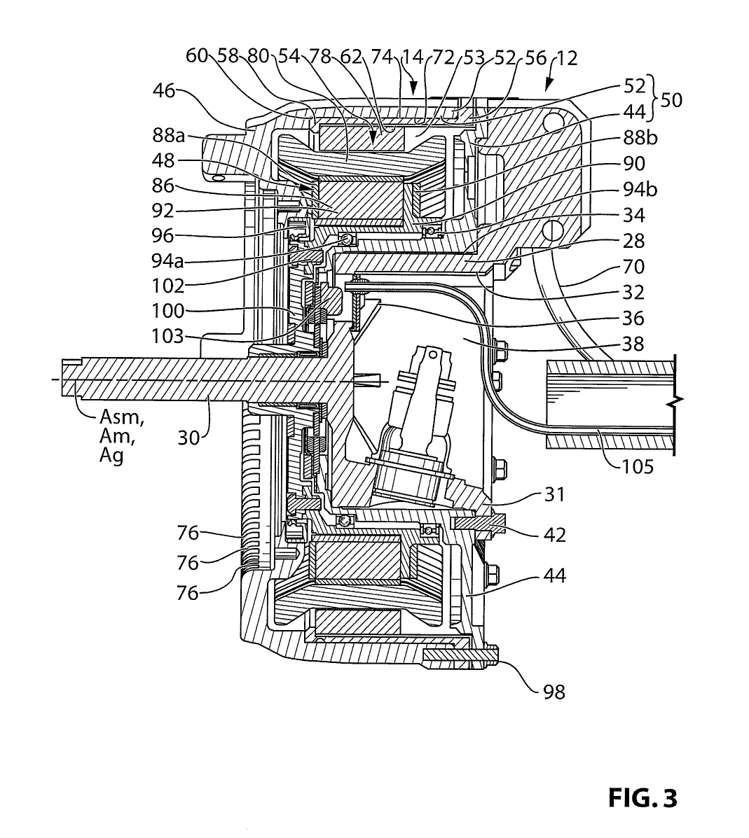

Referring to FIG. 3, the cooling jacket 56 seats against the radially inner surface shown at 72 of the outer housing member 52. Preferably, substantially all of the radially outer surface, shown at 74, of the radially outer jacket housing member 60 is in contact with the radially inner surface 72 of the outer motor housing member 52, to facilitate heat transfer out of the cooling jacket 56 (and into the motor housing member 52). Heat in the outer motor housing member 52 may be dissipated at least in part by a plurality of cooling fins shown at 76.

By having the cooling jacket 56 be positioned within the motor housing 50 (eg. radially inside of the outer motor housing member 52), the cooling jacket 56 is better positioned to receive heat from the operation of the motor 14 and therefore to transport heat out of the motor 14. By contrast, a cooling jacket that is mounted to the exterior of the motor housing 50 would only receive heat that is conducted through the motor housing 50. It is, however, nonetheless within the scope of some aspects of the invention for a cooling jacket to be provided on the exterior of the motor housing 50 instead of on the interior of the motor housing 50.

By having the cooling jacket 56 be made as a self-contained unit is advantageous in that the cooling jacket 56 may be made and tested, prior to assembly of the motor 14. Thus, any defective cooling jackets 56 can be removed before being incorporated into the motor 14. A further, related advantage is that the cooling jacket 56 can be made by another party and shipped to the motor assembler, for example, or to corner assembly assembler, pre-tested and pre-filled with cooling fluid, thereby facilitating the motor assembly process. It is nonetheless within the scope of selected aspects of the present invention, however, for the cooling jacket 56 to not be self-contained and to instead include a jacket housing member that is sealingly connected to the motor housing 50 (eg. by welding) to enclose an interior channel structure for the transport of cooling fluid.

The stator 54 may be mounted directly to the radially inner jacket housing member 58. The stator 54 is a significant source of heat in the electric motor 14. By having the stator 54 in direct connection with the cooling jacket 56, the cooling jacket 56 is positioned to receive more heat from the stator 54, than would be a cooling jacket that is positioned elsewhere (eg. on the exterior of the motor housing 50), and is therefore better positioned to transport more heat away from the stator 54.

The stator 54 may have any suitable structure. For example, the stator 54 may be made up of a plurality of stator laminations 78 and windings 80. The stator windings 80 connect to three electrical conduits 84a, 84b and 84c (FIG. 1b) through a junction block 82 (FIG. 1b).

Referring to FIG. 1b, the three conduits 84a, 84b and 84c may be housed together in a cover 85. The cover 85 extends to a connector 87, which is used to connect the three conduits 84a, 84b and 84c to a voltage source (not shown). By providing the cover 85 and the connector 87, the three conduits 84a, 84b and 84c can be manipulated by an assembly person as a single conduit, thereby facilitating vehicle assembly. Additionally, the cover 85 provided protection for the conduits 84a, 84b and 84c from exposure and damage to the elements during vehicle use.

Referring to FIG. 3, the rotating motor portion 48 is rotatable about a motor axis Am, which is the same axis as the support member axis Asm. The rotating motor portion 48 includes a rotor 86, outboard and inboard balancing plates 88a and 88b and a rotor hub 90. The rotor 86 may have any suitable structure. For example, the rotor 86 may includes a plurality of rotor laminations 92 and a plurality of magnets (not shown). The rotor hub 90 is rotatably supported on the inner motor housing member 44 by first and second motor bearings 94a and 94b. The first and second motor bearings 94a and 94b may each be any suitable type of bearing, such as ball bearings, or tapered roller bearings. An oil seal 96 is positioned between the rotor hub 90 and the outer motor housing member 52.

The rotor hub 90 extends radially inwardly and acts as a motor output member. A gearbox input member 100 is connected to the rotor hub 90 via a plurality of gearbox input member mounting fasteners 102, which may be axially extending fasteners, such as, for example, axially extending bolts.

A plurality of motor assembly fasteners 98 (such as threaded studs and nuts) pass between the inner and outer housing members 44 and 52 and the cooling jacket 56 to hold those components together.

The motor 14 may include a speed sensor, shown at 103, which communicates with a controller (not shown) that controls the speed of the motor 14. The speed sensor 103 may be any suitable type of speed sensor. A speed sensor electrical conduit 105 may extend from the speed sensor 103 to the controller. Alternatively, communication between the speed sensor 103 and the controller may be wireless.

It will be noted that the advantages of providing a cooling jacket that is in the motor interior 53 or a cooling jacket for an electric motor that has the stator mounted to it, or a cooling jacket that is separate from the motor housing are not limited to embodiments wherein the electric motor is a hub motor, (ie. is mounted at the wheel of an electric vehicle). A cooling jacket with any or all of these aforementioned features may be used with other electric motor applications, such as, for example, with an electric motor that is remotely located from the driven wheel, (eg. with an electric motor that is generally centrally positioned in the vehicle and that drives one or more wheels). Also, a cooling jacket with any or all these aforementioned features may be provided with other types of electric motor, such as, for example, an axial flux motor.

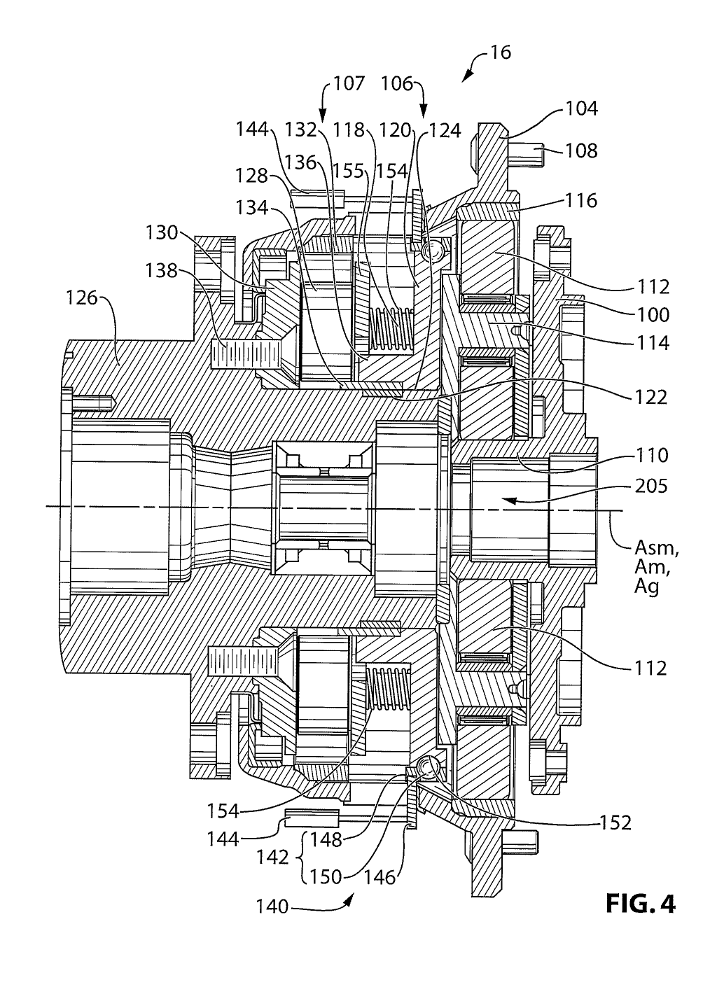

Referring to FIG. 2, the gearbox 16 includes a gearbox housing 104 and at least a first stage of reduction, shown at 106 (shown in FIGS. 2 and 4) and may optionally include a second stage of reduction, shown at 107 (shown in FIG. 4 only). Referring to FIG. 2, the gearbox housing 104 may mount to the non-rotating motor portion 46 or to some other non-rotating member in any suitable way. Advantageously, the gearbox housing 104 mounts to the non-rotating motor portion 46 with a plurality of axially extending fasteners 108, such as axially extending bolts.

The first stage of reduction 106 includes the gearbox input member 100, which may also be referred to as the first stage input member 100. Referring to FIG. 4, the first stage of reduction 106 may include any suitable structure such as, for example, a planetary gear arrangement including the gearbox input member 100, which includes a sun gear 110, a set of first stage planet gears 112, a first stage planet carrier 114, and a first stage ring gear 116. The sun gear 110 is rotatably supported on the non-rotating support member 12 and more specifically on the spindle 30, by means, for example of one or more bearings, such as, for example, a sleeve, and rotates about an axis Ag, which may be the same axis as the support member axis Asm. A thrust bearing may be provided at the inboard end of the gearbox input member 100 The sun gear 110 is rotatably driven by the operative connection of the rotor hub 90 to the gearbox input member 100. The rotatable support of the sun gear 110 may be by any suitable means, such as by an oil lubricated bushing.

The sun gear 110 drives the first stage planet gears 112, which in turn drive the first stage planet carrier 114 to rotate about the axis Ag. The first stage planet carrier 114 has a plurality of axially extending pins 118 thereon. A first stage output member 120 is mounted on the pins 118, and is thus driven by the first stage planet carrier 114 to rotate about the axis Ag.

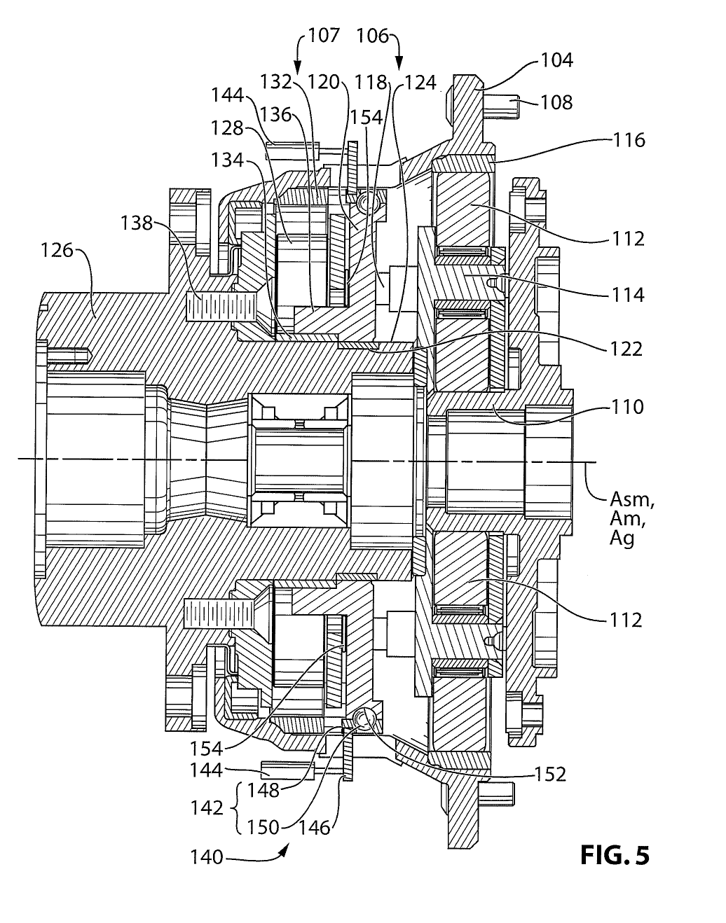

The first stage output member 120 includes a splined aperture 122 that engages a splined portion 124 of a wheel hub 126, which is a portion of the wheel 20. Thus, the first stage output member 120, in the position shown in FIG. 4, is operatively connected to the wheel 20 and is thus the gearbox output member. For the gearbox 16 shown in FIG. 2, the gearbox 16 provides a single, selected ratio between the rotating motor member 48 and the wheel hub 126. For the two-stage gearbox 16 shown in FIG. 4, the first stage output member 120 is positionable in a first position, shown in FIG. 4, or in a second position, shown in FIG. 5. In the position shown in FIG. 4 the first stage output member 120 is operatively connected to the wheel hub 126, through engagement of the splined aperture 122 with the splined portion 124. In the position shown in FIG. 5, the first stage output member 120 acts as a second stage input member 120.

The second stage of reduction 107 may include any suitable structure, such as a planetary gear arrangement. Aside from the second stage input member 120, the second stage of reduction 107 may further include a set of second stage planet gears 128, a second stage planet carrier 130 and a second stage ring gear 132. The second stage input member 120 may be rotatably supported on the non-rotating support member 12 (eg. on the spindle 30) by any suitable means, such as by a needle bearing 134.

The first stage output member 120 includes a second stage sun gear 136. When the first stage output member 120 is in the second position (FIG. 5), When in the second position, the first stage output member 120 is still driven by the first stage planet carrier 114 through the pins 118, however, the splined aperture 122 is separated from the splined portion 124 of the wheel hub 126 and the second stage sun gear 136 is operatively connected to the second stage planet gears 128. Thus, when in the second position, the first stage output member 120 drives the second stage planet gears 128, which in turn drive the second stage planet carrier 130 to rotate about the axis Ag. The second stage planet carrier 130 may be connected to the wheel hub 126 by any suitable means, such as by a plurality of bolts 138. The second stage planet carrier 130 is thus the second stage output member and is the gearbox output member when the first stage output member 120 is in the second position, shown in FIG. 5. In other words, when the first stage output member 120 is in the second position (FIG. 5), the first stage output member 120 is operatively connected to the second stage output member 130, which, in turn, is operatively connected to the wheel 20.

When the first stage output member 120 is moved from the second position (FIG. 5) to the first position (FIG. 4), the second stage sun gear 136 is disengaged from the second stage planet gears 128, and the splined aperture 122 is engaged with the splined portion 124 of the wheel hub 126. To facilitate the engagement between the splined portion 124 and the splined aperture 122 the splines in one or both of the aperture 122 and the portion 124 may have their mutually facing axial edges tapered to that they can mutually engage and assist each other to align as necessary so that they can slide into engagement with each other.

It will be noted that the wheel hub 126 is driven alternatively from two different areas depending on whether it is being driven by the first stage 106 or second stage 107 of the gearbox 16. The splined portion 124 of the wheel hub 126 thus constitutes a first input drive connector on the wheel hub 126 for receiving power from the gearbox 16, and the apertures, shown at 140, into which the bolts 138 pass constitute a second input drive connector on the wheel hub 126 for receiving power from the gearbox 16. When the gearbox 16 drives the wheel hub 126 though the first stage of reduction 106 a first effective reduction is achieved. When the gearbox 16 drives the wheel hub 126 though the first and second stages of reduction 106 and 107, a second effective reduction is achieved, which is greater than the first effective reduction. The first stage of reduction (and thus the first effective reduction) can be used, for example, for road driving, when high speed may be required, but not necessarily high torque. The second stage of reduction (and thus the second effective reduction) can be used, for example, in an off-road environment, when the vehicle may require high-torque, and does not require high speed capability (eg. not more than, for example, about 35 mph, which corresponds to about 56 km/hr).

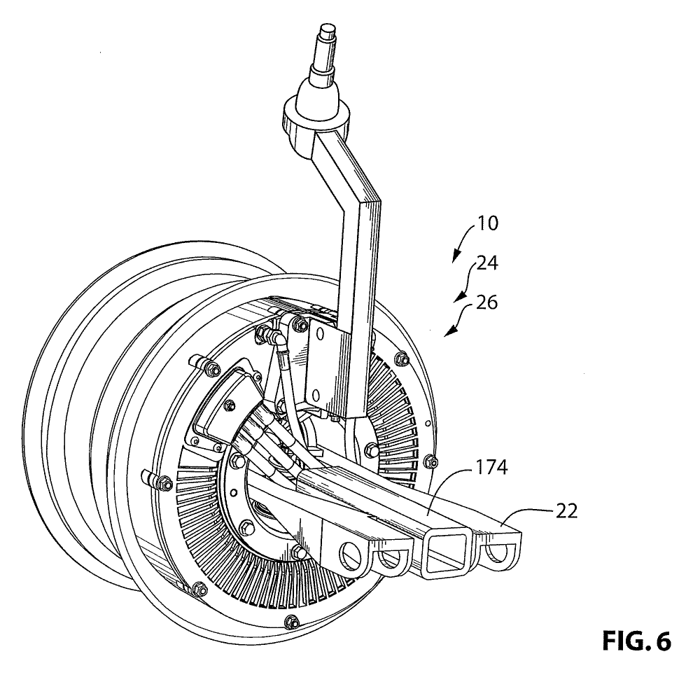

Referring to FIG. 6, a shifter mechanism 140 is used to shift the first stage output member 120 between the first and second positions. The shifter mechanism 140 may be any suitable type of shifter mechanism. For example, the shifter mechanism 140 may include a bearing 142, and a pair of actuators 144 which are 180 degrees apart, each of which is connected to the bearing 142 by way of a shift arm 146. The bearing 142 includes an outer race 148 and a set of balls 150. The balls 150 are captured between a first groove in the outer race 148, and a second groove 152 in the radial edge of the first stage output member 120. As a result, the outer race 148 can be kept stationary while the first stage output member 120 rotates. The shift arm 146 extends from the outer race 148 through a slot in the gearbox housing 104.

The actuator 144 may be any suitable type of actuator, such as a solenoid, or, for example, an air diaphragm. The actuator 144 may be mounted to the shift arm 146 and to the gearbox housing 104. A first stage output member biasing member 154 may be provided for biasing the first stage output member 120 toward the first position (FIG. 4). The first stage output member biasing member 154 may be any suitable type of biasing member, such as, for example, a compression spring, and may be positioned at any suitable position, such as on the axially extending pins 118 on the planet carrier 114 between the first stage output member 120 and a retaining ring shown at 155 that is part of the second stage planet carrier 130. A plurality of biasing members 154 may be provided. For example, a biasing member 154 may be provided on each pin 118. In the event of a failure of the actuator 144 the first stage output member 120 may be moved towards, or held in, the first position (FIG. 4) by the one or more biasing members 154.

The vehicle (not shown) may include a selector switch in the vehicle cabin (not shown) that is accessible to the vehicle driver, for controlling the operation of the actuator 144, optionally through the controller (not shown).

In the embodiment of the gearbox 16 shown in FIG. 2, there is only a single stage of reduction 106; there is no second stage. To maintain commonality of parts between the single stage and two-stage versions of the gearbox 16, the single stage gearbox 16 may include the first stage planet carrier 114 with the pins 118, and may include the same first stage output member 120 as used in the two-stage gearbox 16 shown in FIGS. 4 and 5. In the embodiment shown in FIG. 2, however, the first stage output member 120 is not movable axially and is instead held by some suitable means in a fixed position, which would be considered the first position in the two-stage gearbox 16. In this fixed position the splined aperture 122 of the first stage output member 120 is maintained in permanent engagement with the splined surface 124 of the wheel hub 126.

It will be noted that the gearbox housing 104 may remain the same, whether the drive assembly 24 includes the single stage gearbox 16 shown in FIG. 2 or the double stage gearbox 16 shown in FIG. 4. It will further be noted that the diameters of the sun gear 110, planet gears 112 and the ring gear 116, and in embodiments where they are provided, the sun gear 136, the planet gears 128 and the ring gear 132 can all be selected to provide a selected ratio or set of ratios while fitting in the same axial space and fitting within the same gearbox housing 104. This flexibility permits a range of gearboxes 16 to be incorporated into the drive assembly 24 permitting the corner assembly 10 to be tailored for various different purposes that differ in terms of torque and speed requirements.

It will be understood that the gearbox 16 could optionally be configured with additional stages if desired. For example, one or more additional stages could be added using similar structure that makes up the second stage of the gearbox 16 shown in FIG. 4.

Referring to FIG. 2, the brake 18 is used to stop the rotation of the wheel 20. The brake 18 is preferably used in conjunction with regenerative braking that may be provided by the motor 14.

The brake 18 comprises a brake rotor 156, and a caliper 158. The brake rotor 156 may be any suitable type of rotor, such as a vented rotor, as shown in the figures. The brake rotor 156 has a brake rotor aperture 157 and is mounted to the wheel hub 126 such that the wheel hub 126 passes through the brake rotor aperture 157. A plurality of axially extending brake rotor mounting fasteners 161 pass through the brake rotor 156 and the wheel hub 126 to fix the brake rotor 156 to the wheel hub 126.

The brake caliper 158 may be operated hydraulically or in any other suitable way for engaging and stopping rotation of the brake rotor 156, which stops rotation of the wheel 20. In embodiments wherein the brake caliper 158 is hydraulically operated, a hydraulic fluid conduit 159 extends between the caliper 158 and a remotely positioned source of hydraulic fluid (not shown). The brake caliper 158 is mounted to a non-rotating member, such as the outer motor housing member 52. A brake pad 160 is provided on each rotor-engaging face of the brake caliper 158.

The brake rotor 156 and brake pads 160 may be relatively thin for space efficiency, without unduly reducing the effective life of the brake rotor 156 relative to brake rotors and brake pads on typical vehicles with internal combustion engines, since some portion of the kinetic energy of the vehicle (not shown) is absorbed through the regenerative braking feature of the motor 14.

It is possible to provide a wheel assembly 26 without the brake 18 with the expectation that a mechanical brake of some kind will be incorporated into the vehicle (not shown). In other words, a supplier could ship to a vehicle assembler a wheel assembly 26 that provides many of the advantageous features described above without including a brake in that wheel assembly, with the expectation that the vehicle assembler will add a mechanical brake as necessary.

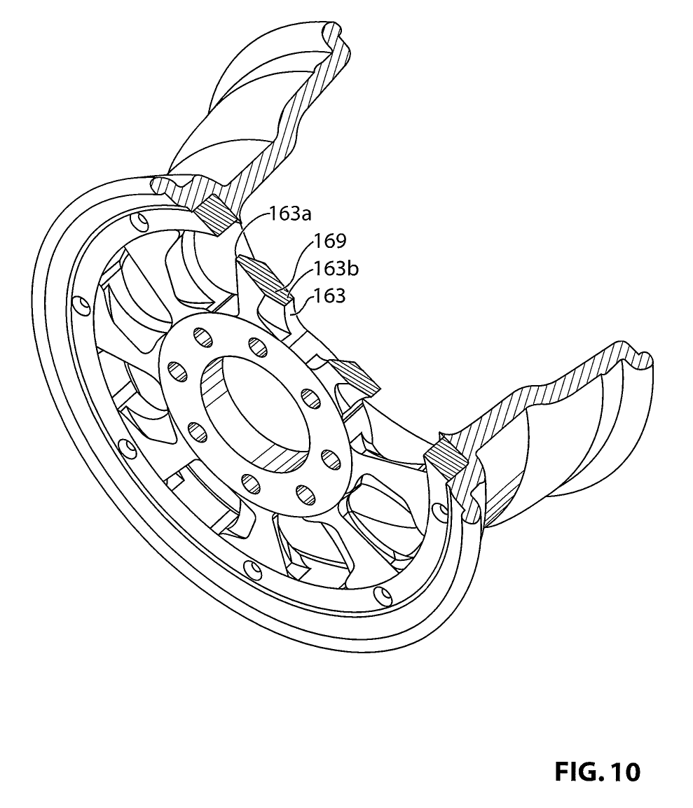

Referring to FIG. 2, the wheel 20 is rotatably supported by the non-rotating support member 12, and may specifically be supported by the spindle 30, as shown in the figures. The wheel 20 includes a rim 162, a spider 164 and the wheel hub 126. Functionally, the rim 162 is the portion of the wheel 20 that hold a tire (not shown). The wheel hub 126 is the portion of the wheel 20 that mounts to the non-rotating support member 12 and receives components such as the brake rotor 156. The spider 164 is the portion that connects the rim 162 and the wheel hub 126. The spider 164 may be configured to facilitate airflow to components housed by the wheel 20, such as the brake rotor 156. Such a configuration of the spider 164 is shown in FIG. 10. As the wheel 20 is rotated during use, the vanes of the spider 164 direct airflow inwardly towards the components housed therein. The vanes of the spider 164 are shown at 163. The vanes 163 may have leading edge portions 163a and trailing edge portions 163b that are angled in such a way to direct airflow inwardly when the wheel 20 is rotated in a selected angular direction shown by arrow 169.

The rim 162, spider 164 and wheel hub 126 may all be separate components that are fastened together, as shown in the figures. Specifically, a plurality of axially extending rim mounting fasteners 165 may be used to fix the rim 162 to the spider 164. The spider 164 may be fixed to the wheel hub 126 by the brake rotor mounting fasteners 161, which may pass through the spider 164 in addition to passing through the brake rotor 156 and the wheel hub 126. The brake rotor mounting fasteners 161 may thus also be referred to as spider mounting fasteners 16. Alternatively any or all of the components of the wheel 20 may be integrally joined with each other. For example, the entire wheel 20 may be cast as a single integral piece.

The wheel hub 126 is supported on the spindle 30 by first and second wheel bearings 166a and 166b, which may be any suitable type of bearings, such as, for example, tapered roller bearings. Optionally, the wheel hub 126 may further be supported by a third wheel bearing 167, as shown in FIG. 2. The third wheel bearing 167 may be any suitable type of bearing, such as, for example, a roller bearing. The bearing 167 may be omitted so that the wheel hub 126 is rotatably supported on the spindle 30 by the first and second bearings 166a and 166b only. It will be noted that the bearings that support the wheel 20, namely the wheel bearings 166a, 166b, and, the optionally included third bearing 167, are entirely separate from the bearings that support the motor 14, namely the motor bearings 94a and 94b. As a result, the motor 14 is at least partially isolated from vibrations that are incurred by the wheel 20 as the vehicle travels on a surface (eg. a road). Such vibrations are absorbed in part by the wheel bearings 166a, 166b, and 167 and are reduced further by the motor bearings 94a and 94b are thus reduced in severity before reaching the rotating motor portion 48. Damping these vibrations before reaching the rotating motor portion 48 by providing separate support bearings for the motor 14 and the wheel 20 may extend the operating life of the motor 14.

To prevent the wheel hub 126 from being pulled axially outward off the non-rotating support member 12 when there are lateral forces on the vehicle (eg. during a cornering maneuver), a wheel locking assembly 180 is provided. The wheel locking assembly 180 comprises a washer 182 that axially slides onto the non-rotating support member 12 and engages the outboard wheel bearing 166a, a locknut 184 that holds the washer 182 in place, and a cap 186 with a seal member 188 (eg. an o-ring). The cap 186 with the seal member 188 cooperate to seal off the outboard wheel bearing 166a from exposure to dirt, moisture and other potential contaminants that could cause premature failure of the bearing 166a. The cap 186 also prevents the locknut 184 from working its way off the end of the non-rotating support member 12 over time. The cap 186 may itself fixed to the wheel hub 126 by means of a plurality of fasteners 190 such as bolts.

It will be noted that the motor 14 is supported on the knuckle 28, and the wheel 20, the brake 18 and the gearbox 16 are supported on the spindle 30. The configuration of the knuckle 30 (ie. its relatively large diameter and the presence of the gussets 36) provides the knuckle 28 with a high resistance to deflection from bending forces such as impact forces incurred by the wheel 20 on road imperfections such as potholes. The spindle 30 however has a lower resistance to deflection than the knuckle 30. Supporting the wheel 20 on the spindle 30 is advantageous because the deflection of the spindle 30 absorbs some of the impact energy from impacts by the wheel 30 on road imperfections thereby reducing the amount of energy that is transmitted into the rest of the vehicle (not shown) from such impacts. Supporting the motor 14 on the knuckle 28, however, is advantageous because the rotor 86 and stator 54 are less likely to be brought out of alignment with each other by wheel impacts, and as a result, the gap between the rotor 86 and stator 54 may remain more constant, thereby potentially improving the operating life of the motor 14. The ratio of the bending resistance of the knuckle 28 to that of the spindle 30 may be any suitable ratio, such as, for example, approximately 500:1.

Referring to FIG. 6, mounted on the radially inner surface 32 of the knuckle 30 is a ball joint 168 for receiving the lower control arm 22. As a result of being mounted to the radially inner surface 32, the ball joint 168 is protected at least somewhat from damage due to objects being driven over during use of vehicle, such as rocks on a path that may be encountered during off-road use, in embodiments wherein the vehicle is off-road capable.

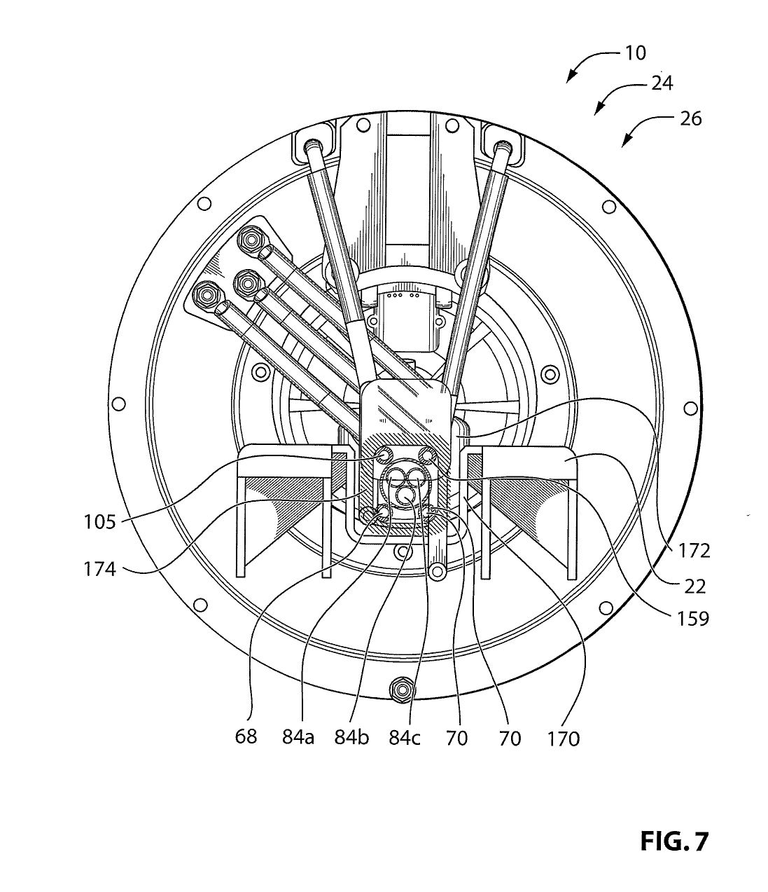

The lower control arm 22 may include a channel portion 170 that defines a channel 172, shown more clearly in FIG. 7. The channel 172 may be sized to be sufficient to carry any conduits that extend from the wheel assembly 26, including the three electrical conduits 84a, 84b and 84c that connect to the electric motor 14, the coolant conduits 68 and 70 that transport coolant to the cooling jacket 56, the hydraulic conduit 159 that carries hydraulic fluid to the brake 18, and the speed sensor electrical conduit 105. By running the aforementioned conduits along the channel 172 the conduits are protected at least somewhat from damage from debris, dirt, salt, rocks or other potentially damaging materials and objects that the vehicle could encounter during use.

Referring to FIG. 1a, the conduits may all run in a protective cover conduit 174. The cover conduit 174 may be a corrugated plastic tube that is easily laid in the channel 172 of the lower control arm 22 (see FIG. 7). The cover conduit 174 thus facilitates vehicle assembly, and further protects the conduits from damage from the elements, or from mechanical damage during vehicle use.

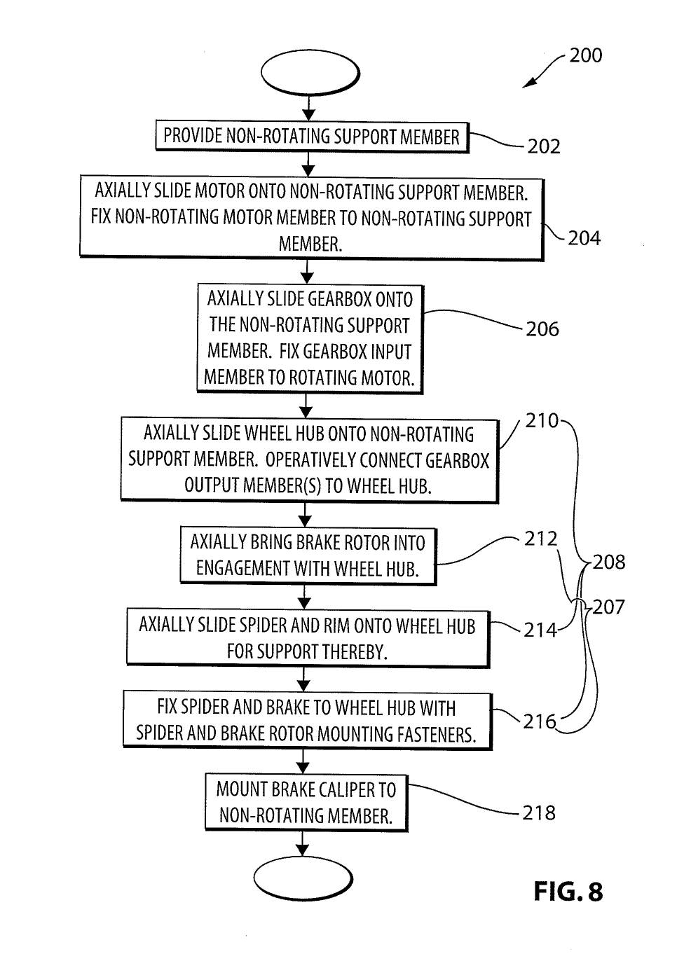

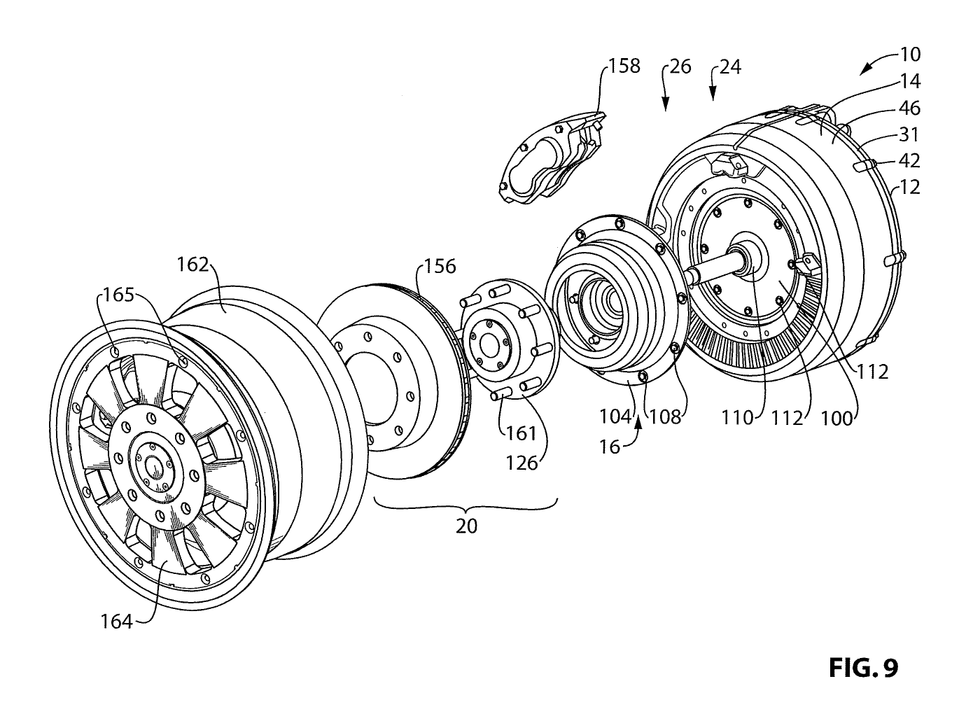

Reference is made to FIGS. 8, 9 and 3, which show a method 200 (FIG. 8) of assembling the wheel assembly 26 (FIG. 9). As a result of the modularity of the components of the wheel assembly 26, the assembling of the wheel assembly 26 may be easily carried out. Additionally, components may be substituted for other components easily and with little change in the assembly process.

At step 202 (FIG. 8), the non-rotating support member 12 (FIG. 9) is provided. The non-rotating support member 12 may be positioned on a fixture with the spindle 30 facing upwards. At step 204 (FIG. 8), the motor 14 (FIG. 9) is axially slid onto the non-rotating support member 12, (specifically the knuckle 28—as shown in FIG. 3) for support thereon, and is fastened to the flange 31 by means of the motor mounting fasteners 42 thereby fixing the non-rotating motor portion 46 to the non-rotating support member 12. With continuing reference to FIG. 3, in some embodiments, the motor 14 may be mounted to the knuckle 28 as a complete unit. In other words, the motor 14 may be assembled together prior to being slid onto the knuckle 28. In other embodiments, however, certain components of the motor 14 may be mounted to the knuckle 28 before other components are added. For example, the inner motor housing member 44 may be slid onto the knuckle 28, and then the rotating motor portion 48 may be mounted onto the inner motor housing member 44 using the bearings 94a and 94b. Afterwards, the stator 54, the cooling jacket 56 and the outer motor housing member 52 may be mounted onto the inner motor housing member 44 and bolted thereto using the axially extending motor assembly fasteners 98. The axially extending motor mounting fasteners 42 may be used to mount the inner motor housing member 44 to the non-rotating support member 12 at any suitable point, (eg. after the outer and inner motor housing members 52 and 44 are assembled together). The speed sensor 103 and associated electrical conduit 105 may be mounted to the non-rotating support member 12 at any suitable time, such as prior to the installation of the motor 14.

At step 206 (FIG. 8), the gearbox 16 (FIG. 9) is mounted for receiving power from the electric motor 14. This may entail a sequence of steps in itself, wherein certain gearbox components are mounted prior to other gearbox components. For example, the gearbox input member 100 (FIG. 3), which includes a gearbox input member aperture 205 (FIG. 4), may be axially slid onto the non-rotating support member 12 (in particular the spindle 30—see FIG. 3) for support thereon, until the gearbox input member 100 engages the rotor hub 90. The gearbox input member 100 is fixed to the rotor hub 90 using the axially extending fasteners 102. The remainder of the gearbox 16 (FIG. 9) may be installed in one or more separate steps. For example, the rest of the gearbox 16 may be assembled together and may be slid as a unit onto the spindle 30 to a position wherein the sun gear 110 is engaged with the first stage planet gears 112 (FIG. 4) and the gearbox housing 104 (FIG. 9) is engaged with the non-rotating motor member 46 and can be mounted thereto using the axially extending fasteners 108.

At step 207 (FIG. 8), the brake rotor 156 is axially brought into engagement with the wheel 20 and is fixed thereto with the axially extending brake rotor mounting fasteners 161.

At step 208, the wheel 20 is axially slid onto the non-rotating support member 12 such that the non-rotating support member 12 rotatably supports the wheel 20 through the wheel bearings 166a, 166b and 167 (FIG. 2). The wheel 20 may be mounted in such a way that one or both of the gearbox output members (ie. the first stage and second stage output members 120 and 130) are operatively connected to the wheel 20 (eg. through the wheel hub 126).

Several of the above steps need not take place strictly in sequence. For example, referring to FIG. 2, the gearbox input member 100 could be mounted to the rotor hub 90 prior to the mounting of certain motor components, such as the stator 54, cooling jacket 56 and outer motor housing member 52. Similarly, step 207 (FIG. 8) need not take place prior to step 208. In embodiments wherein the wheel 20 (FIG. 9) includes a wheel hub 126 that is removably connectable with the spider 164, steps 207 (FIG. 8) and 208 may together be subdivided into further steps, as follows: At step 210, the wheel hub 126 (FIG. 9) may be slid axially onto the non-rotating support member 12 such that the non-rotating support member 12 rotatably supports the wheel hub 126, and the one or more gearbox output members are operatively connected to the wheel hub 126. At step 212 (FIG. 8) the brake rotor 156 is axially brought into engagement with the wheel hub 126. At step 214 (FIG. 8) the spider 164 (FIG. 9) and the rim 162 are axially slid onto the wheel hub 126 for support thereby. At step 216 (FIG. 8), the spider 164 (FIG. 9) and the brake rotor 156 are fixed to the wheel hub 126 by the mounting fasteners 161, which act as both brake rotor mounting fasteners and spider mounting fasteners.

At step 218 (FIG. 8), the brake caliper 158 (FIG. 9) is mounted to a non-rotating member, such as the non-rotating motor portion 46 or the gearbox housing 104, so as to be selectively operable to stop rotation of the brake rotor 156.

Elements from the suspension may be mounted at any suitable point in the assembly process. For example, the ball joint 168 (FIG. 2) may be mounted in the non-rotating support member 12 prior to step 204 (FIG. 8).

It will be apparent to one skilled in the art upon review of the disclosure herein that at least some the aforementioned assembly steps need not be carried out in the precise order they are shown in FIG. 8.

It will be noted that not all of the structure shown in the figures need be provided in order to achieve some aspects of the invention. For example, a wheel assembly that supports the electric motor on separate bearings from those that support the wheel need not include a gearbox at all. As another separate example, a wheel assembly that supports the electric motor on a large diameter knuckle (to inhibit deflection) while supporting the wheel on a smaller diameter spindle (to permit a selected amount deflection) need not include a gearbox at all. As yet another example, a corner assembly that holds the electrical conduits from a motor in a channel in the lower control arm need not include a gearbox at all. As yet another example, at least some advantages associated with providing the cooling jacket described herein for the electric motor can be achieved whether or not the motor is supported on a non-rotating support member is provided, and regardless of the support member's configuration if it is provided.

While the above description constitutes a plurality of embodiments of the present invention, it will be appreciated that the present invention is susceptible to further modification and change without departing from the fair meaning of the accompanying claims.

1. A wheel assembly for a vehicle, comprising:
a non-rotating support member;
a wheel including a rim, a spider and a wheel hub, the rim having a radially inner surface, wherein the wheel is rotatably supported by the non-rotating support member for rotation about a wheel axis;
an electric motor having an axially extending motor aperture, wherein the electric motor includes a non-rotating motor portion and a rotating motor portion, wherein the rotating motor portion is operatively connected to the wheel and is spaced from the radially inner surface of the rim for substantial isolation from any radially inwardly directed forces from the radially inner surface of the rim, wherein the non-rotating motor portion is fixedly connected to the non-rotating support member; and
a gearbox that is driven by the rotating motor portion and that drives the wheel, wherein the gearbox is spaced from the radially inner surface of the rim for substantial isolation from any radially inwardly directed forces from the radially inner surface of the rim.

2. A wheel assembly as claimed in claim 1, wherein the wheel is supported by the non-rotating support member through a first wheel bearing and a second wheel bearing, and the motor is supported by the non-rotating support member through a first motor bearing and a second motor bearing.

3. A wheel assembly as claimed in claim 1, wherein the non-rotating support member includes a spindle and a knuckle, wherein the spindle is axially outboard of the knuckle, wherein the non-rotating portion of the motor is connected to the knuckle, and the wheel is supported by the spindle.

4. A wheel assembly as claimed in claim 1, wherein the rotating motor portion is connected to the wheel through the wheel hub.

5. A wheel assembly as claimed in claim 1, wherein the rotating motor portion is spaced from the radially inner surface of the rim by an air gap.

6-11. (canceled)

12. A drive assembly for a vehicle, comprising:
A non-rotating support member;
an electric motor supported by the non-rotating support member and having a non-rotating motor portion and a rotating motor portion;
a wheel rotatably supported by the non-rotating support member; and
a gearbox having at least two selectable ratios associated therewith, wherein the electric motor is operatively connected to the gearbox, and wherein the gearbox is operatively connected to the wheel,
wherein the gearbox includes a first stage and a second stage, wherein the first stage includes a first stage input member drivable by the rotating motor portion and a first stage output member drivable by the first stage input member, and the second stage includes a second stage output member, wherein the first stage output member is movable between a first position and a second position, wherein in the first position the first stage output member is operatively connected to the wheel such that the wheel is driven by the first stage output member without being driven by the second stage, and wherein in the second position the first stage output member is operatively connected to the second stage output member and the second stage output member is operatively connected to the wheel.

13. A drive assembly as claimed in claim 12, wherein the wheel includes a hub having a first input drive connector and a second input drive connector, wherein, in the first position the first stage output member is operatively connected to the first input drive connector and in the second position the second stage output member is operatively connected to the second input drive connector.

14. A drive assembly as claimed in claim 12, wherein the first stage input member includes a sun gear and wherein the first stage further includes a plurality of first stage planet gears, a first stage ring gear and a first stage planet carrier, wherein the first stage output member is slidable axially between the first position and the second position, and is rotatable by the first stage planet carrier in both the first and second positions.

15. A drive assembly as claimed in claim 14, wherein the second stage includes a plurality of second stage planet gears, a second stage ring gear and a second stage planet carrier that is the second stage output member, wherein in the second position the first stage output member is a second stage sun gear for the second stage planet gears.

16-42. (canceled)

43. A method of assembling a wheel assembly, comprising:
(a) Providing a non-rotating support member having a non-rotating support member axis;
(b) providing an electric motor, wherein the electric motor includes a rotating motor portion and a non-rotating motor portion including a motor housing, wherein the rotating motor portion is rotatably supported on the motor housing, wherein the electric motor has an axially extending motor aperture defined by the motor housing;
(c) axially sliding the electric motor onto the non-rotating support member, such that the non-rotating support member passes through the motor aperture and supports the motor housing;
(d) Fixing the non-rotating motor portion to the non-rotating support member;
(e) Providing a gearbox having at least one gearbox input member and at least one gearbox output member;
(f) Axially sliding the gearbox onto the non-rotating support member, such that the at least one gearbox input member and the at least one gearbox output member are rotatable relative to the non-rotating support member;
(g) operatively connecting the rotating motor portion to the at least one gearbox input member;
(h) axially sliding a wheel onto the non-rotating support member such that the non-rotating support member rotatably supports the wheel; and
(i) operatively connecting the at least one gearbox output member to the wheel.

44. A method of assembling a wheel assembly as claimed in claim 43, wherein the wheel includes a wheel hub, a spider and a rim, wherein the wheel spider is removably connectable to the wheel hub.

45. A method of assembling a wheel assembly as claimed in claim 44, wherein step (h) includes:
(j) axially sliding the wheel hub onto the non-rotating support member in such a way that the non-rotating support member rotatably supports the wheel hub;
(k) operatively connecting the at least one gearbox output member to the wheel hub;
(l) axially bringing a brake rotor into engagement with the wheel hub;
(m) axially sliding the spider and rim onto the wheel hub so that the wheel hub supports the spider and rim after step (l);
(n) axially driving a plurality of brake rotor mounting fasteners into engagement with the brake rotor and the wheel hub to fix the brake rotor to the wheel hub;
(o) axially driving a plurality of spider mounting fasteners into engagement with the spider and the wheel hub to fix the spider to the wheel hub; and
(p) mounting a brake caliper to a non-rotating member such that the brake caliper is operable to stop rotation of the brake rotor.

46. A method of assembling a wheel assembly as claimed in claim 45, wherein the brake rotor mounting fasteners and the spider mounting fasteners are the same, and steps (n) and (o) occur simultaneously and include axially driving the said same fasteners into engagement with the brake rotor, the wheel hub and the spider to fix the spider and the brake rotor to the wheel hub.

47. A method of assembling a wheel assembly as claimed in claim 46, wherein steps (l), (m), (n) and (o) are carried out prior to carrying out step (j).

48. A method of assembling a drive assembly as claimed in claim 43, wherein the non-rotating motor portion includes a stator and a motor housing that includes a radially outer housing portion and a radially inner housing portion that is fixedly connected to the radially outer housing portion, wherein the rotating motor portion is rotatably supported on the radially inner housing portion.

49-50. (canceled)
